(19) United States
(12) Patent Application Publication
(10) Pub. No.: US 2008/0141481 A1
(43) Pub. Date: Jun. 19, 2008

(54) Screw bit putty knife

(75) Inventors: Romeo Arvinte, Ville St.-Laurent (CA); Francois Panfili, Berthierville (CA)

Correspondence Address: DARBY & DARBY P.C., P.O. BOX 770, Church Street Station, New York, NY, 10008-0770, US

(73) Assignee: A. Richard S.E.N.C., Berthierville (CA)

(21) Appl. No.: 11/999,258

(22) Filed: Dec. 3, 2007

Related U.S. Application Data
(60) Provisional application No. 60/861,973, filed on Dec. 1, 2006.

(51) Int. Cl. A47L 13/02; B25B 15/00; B25B 23/16

(52) U.S. Cl. 15/236.01; 7/165; 81/177.3; 81/177.4

(57) ABSTRACT

A utility tool, such a putty knife, includes an elongated handle for manual handling of the utility tool, a blade and a screw bit mechanism. The handle extends substantially along a longitudinal axis, and has front and rear portions. The blade has an anchoring portion anchored within the handle and an operating portion extending out from the front portion of the handle. The screw bit mechanism is rotatably mounted about the rear portion of the handle, has a screw bit, and is operable between a non-operating configuration where the screw bit is nested within the handle, and an operating configuration where the screw bit is drawn out of the handle and securely maintained in a fixed configuration so as to be positioned at a slanted angle with respect to the longitudinal axis of the handle. In addition to being able to carry out other various functions, in drywall applications and the like, the tool by virtue of its design and components enables a more ergonomic grip, and to have a greater lever effect for screwing fasteners with its screw bit mechanism.

### FIELD OF THE INVENTION

The present invention relates to a utility tool. More particularly, in its intended preferred use, the present invention relates to a utility tool (e.g. a putty knife) having an improved tool handle, that is, with integrated and retractable screw bit mechanism, for screwing purposes in drywall applications and the like, designed also for carrying out other related multitask functions. The present application claims priority of U.S. provisional patent application No. 60/861,973 dated Dec. 1, 2006, the contents of which is incorporated herein by reference.

### BACKGROUND OF THE INVENTION

Known in the art are various utility tools used for drywall applications and the like, such as putty knives, screwdrivers, and the like.

The Assignee of the present application has developed several of such products, some of which are described in the following US patents and industrial designs: U.S. Pat. Nos. 6,629,331; 6,719,620; 6,726,868; 6,742,215; 6,775,912; D258,043; D263,277; D414,395; D431,993; D435,408; D463,639; D474,389; D541,998; D555,361; D555,362 and D555,363, the contents of which are also incorporated herein by reference.

It is also known in the art that workers need to use different tools in order to carry out different tasks during drywall applications and the like, and the use of different tools is somewhat disadvantageous in that, namely, time is wasted when going from one tool to another, and that additional space is required for the provision of such various tools in a given tool box, tool belt, etc. Therefore, it would be useful to provide a tool, such as a putty knife for example, which would be devised to carry out several tasks which would normally be done by means of a plurality of different other corresponding tools.

Also known to the Applicant are the following US patents and industrial design which describe various utility tools and the like, some of which contain integrated and retractable screwdriver attachments: U.S. Pat. Nos. 3,774,252; 5,063,627; 5,720,063; 5,870,786; 5,927,164; 6,131,222; 6,272,708 B1; 6,530,098 B1; 6,662,521 B1; 6,769,147 B1; 6,996,868 B1; and D380,661.

Some of the aforementioned utility tools comprise integrated and retractable screw bit mechanisms, but these mechanisms are known to be not optimal in terms of design, ergonomics, easy of use and the other considerations.

Hence, in light of the aforementioned, there is a need for a utility tool, which by virtue of its design and components, would be able to overcome some of the above-discussed prior art concerns.

### SUMMARY OF THE INVENTION

The object of the present invention is to provide a utility tool, which by virtue of its design and components, satisfies some of the above-mentioned needs and is thus an improvement over other related utility tools and/or methods known in the prior art.

In accordance with the present invention, the above object is achieved, as will be easily understood, with a tool handle (and resulting “tool”), such as the one briefly described herein, and such as the one exemplified in the accompanying drawings. Preferably, the resulting tool is a putty knife with integrated and retractable screw bit mechanism for drywall applications and the like, as well as being also devised to carry out other related multitask functions.

More particularly, according to the present invention, there is provided a utility tool comprising:

an elongated handle for manual handling of the utility tool, the handle extending substantially along a longitudinal axis, and having front and rear portions;

a blade having an anchoring portion anchored within the handle and an operating portion extending out from the front portion of the handle; and

a screw bit mechanism rotatably mounted about the rear portion of the handle, the screw bit mechanism having a screw bit, and being operable between a non-operating configuration where the screw bit is nested within the handle, and an operating configuration where the screw bit is drawn out of the handle and securely maintained in a fixed configuration so as to be positioned at a slanted angle with respect to the longitudinal axis of the handle.

According to another aspect of the present invention, there is also provided a putty knife comprising:

an elongated handle for manual handling of the putty knife, the handle extending substantially along a longitudinal axis, and having front and rear portions;

a blade having an anchoring portion anchored within the handle and an operating portion extending out from the front portion of the handle; and

a screw bit mechanism rotatably mounted about the rear portion of the handle, the screw bit mechanism having a screw bit, and being operable between a non-operating configuration where the screw bit is nested within the handle, and an operating configuration where the screw bit is drawn out of the handle and securely maintained in a fixed configuration so as to be positioned at a slanted angle with respect to the longitudinal axis of the handle;

wherein the slanted angle is comprised between about 90 degrees and about 180 degrees with respect to the longitudinal axis of the handle;

wherein the handle comprises an inner core made of a substantially rigid material, while comprising corresponding overlaying portions made of an elastomeric material, for improving manipulation and grip of the handle and of the corresponding putty knife;

wherein the screw bit mechanism is provided with a finger receiving portion for enabling a swiveling of the screw bit mechanism into the operating configuration via a pressing action by a corresponding finger of a user of the putty knife onto said finger receiving portion;

wherein the finger receiving portion comprises a protuberance extending beyond a peripheral layout of the handle;

wherein the protuberance is provided with a series of corresponding transversal ribs for facilitating an improved grip and corresponding activation of the finger receiving portion;

wherein the screw bit mechanism comprises a swiveling support portion having a socket for receiving at least one corresponding removable screw bit intended to be used with the putty knife;

wherein the socket is complementary in shape and size to the at least one corresponding removable screw bit so as to retain the same within the socket, and

wherein the socket is further cooperable in a magnetized manner with respect to said at least one corresponding removable screw bit so as to further retain the same within the socket;

wherein the screw bit mechanism is configured so that its swiveling support portion and corresponding screw bit are retracted and lodged within the handle of the putty knife when said putty knife is in the non-operating configuration;

wherein the screw bit mechanism is provided with a spring cooperable between the inside of the handle and the screw bit mechanism so as to maintain the same in an elevated configuration when operated into the operating configuration, and so as to further maintain the same in a closed configuration when operated into the non-operating configuration;

wherein the screw bit mechanism comprises rounded off portions for a greater comfort of a user of the handle and resulting putty knife when the screw bit mechanism is in the non-operating configuration;

wherein the screw bit mechanism is provided with a flat end positioned, shaped and sized to carry out the function of a nailing cap when the screw bit mechanism is in the non-operating configuration;

wherein the screw bit mechanism and the blade reach one another inside of the handle of the putty knife for enabling to transmit the force from the extremity of the blade to the nailing cap;

wherein the support portion of the screw bit mechanism, and the screw bit, are shaped, positioned and sized so as to define a given leeway space between the handle of the putty knife and a given wall surface when the putty knife is operated onto said given wall surface via its screw bit mechanism;

wherein the handle is provided with a corresponding bore extending through the handle, for enabling to hang the putty knife onto a corresponding hook or other suitable support structure;

wherein at least one sign is produced on the handle, the sign being selected from the group consisting of names, words, numbers, logos, trademarks and symbols conveying information; and

wherein either one of the handle, front portion and rear portion of the putty knife are provided with a reinforcement selected from the group consisting of ribs, flanges, and shoulders.

According to yet another aspect of the present invention, there is also provided a method for operating the above-mentioned tool handle and/or resulting utility tool.

According to yet another aspect of the present invention, there is also provided a kit with components for assembling the above-mentioned tool handle and/or resulting utility tool.

According to yet another aspect of the present invention, there is also provided a set of components for interchanging with components of the above-mentioned tool handle and/or resulting utility tool.

According to yet another aspect of the present invention, there is also provided a method for assembling components of the above-mentioned kit and/or set.

According to another aspect of the present invention, there is also provided a method of manufacturing the above-mentioned tool handle and/or resulting utility tool.

According to another aspect of the present invention, there is also provided a wall surface having been treated with the above-mentioned tool handle and/or resulting utility tool.

The objects, advantages and other features of the present invention will become more apparent upon reading of the following non-restrictive description of preferred embodiments thereof, given for the purpose of exemplification only, with reference to the accompanying drawings.

### BRIEF DESCRIPTION OF THE DRAWINGS

FIG. 1 is a perspective view of a utility tool according to a preferred embodiment of the present invention, the tool being shown with the screw bit mechanism in an operating configuration (“opened configuration”).

FIG. 2 is front plan view of what is shown in FIG. 1.

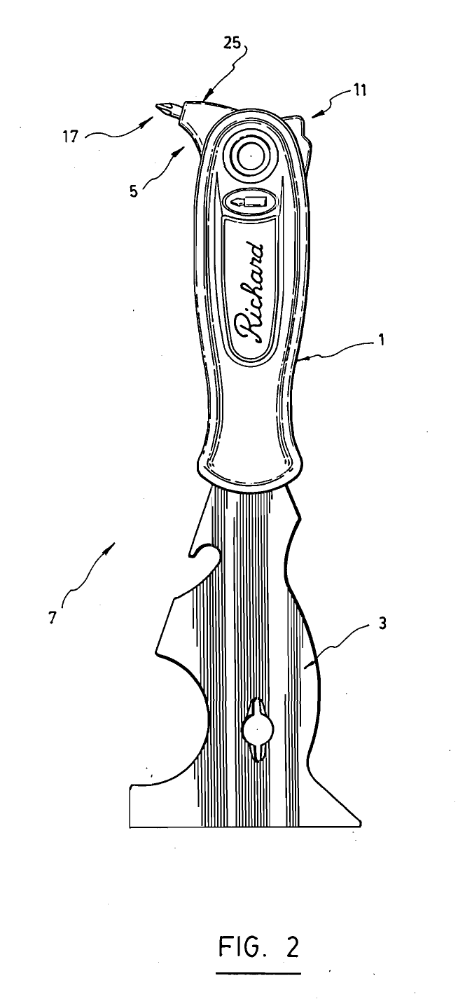

FIG. 3 is an enlarged view of the handle of the utility tool shown in FIG. 2.

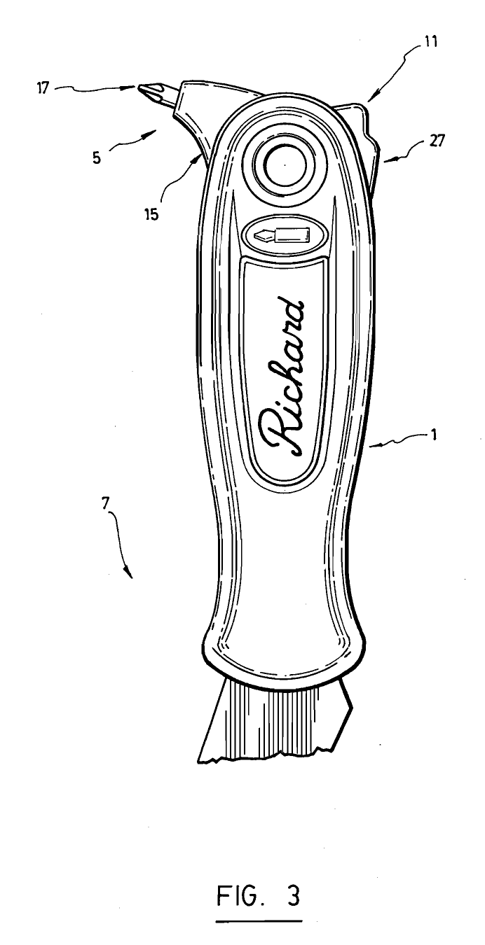

FIG. 4 is another view of what is shown in FIG. 3, the handle being now shown with the screw bit removed from the screw bit mechanism.

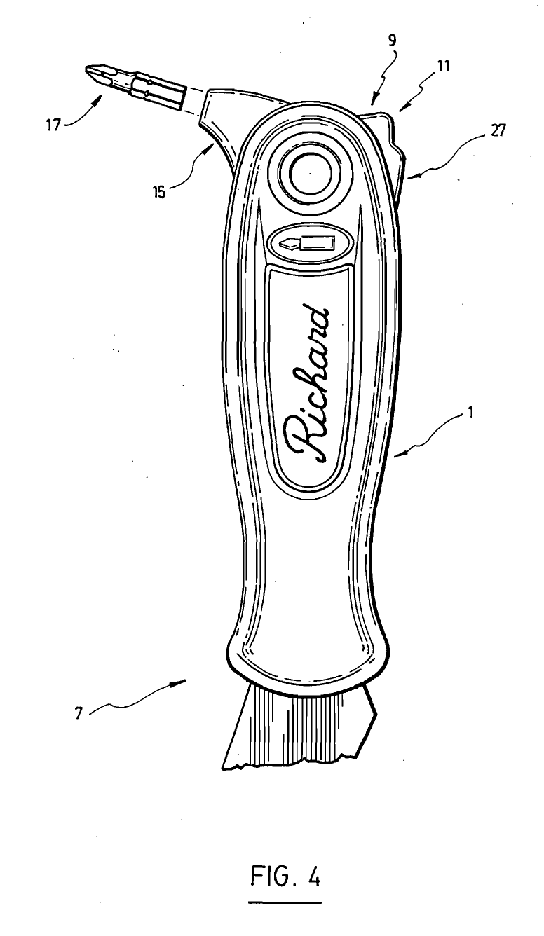

FIG. 5 is an enlarged view of an inside portion of the handle shown in FIG. 4 with the screw bit mechanism illustrated in the operating configuration without its screw bit.

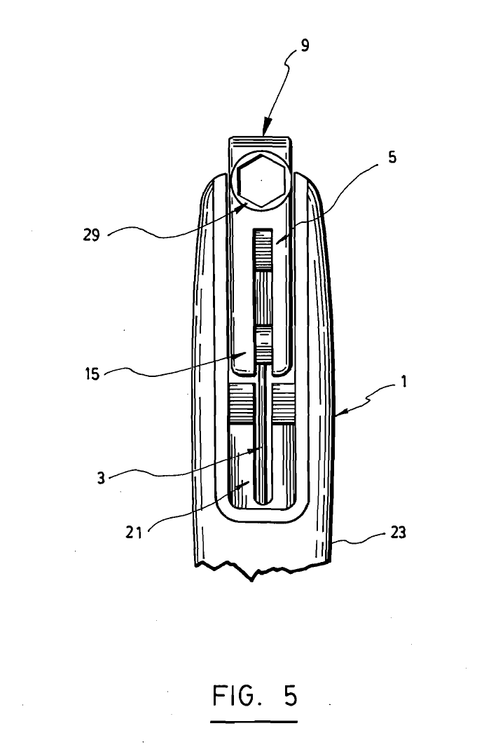

FIG. 6 is a perspective view of a utility tool according to yet another preferred embodiment of the present invention, the tool being also shown with its screw bit mechanism in an operating configuration (“opened configuration”).

FIG. 7 is a front plan view of what is shown in FIG. 6.

FIG. 8 is a rear plan view of what is shown in FIG. 6.

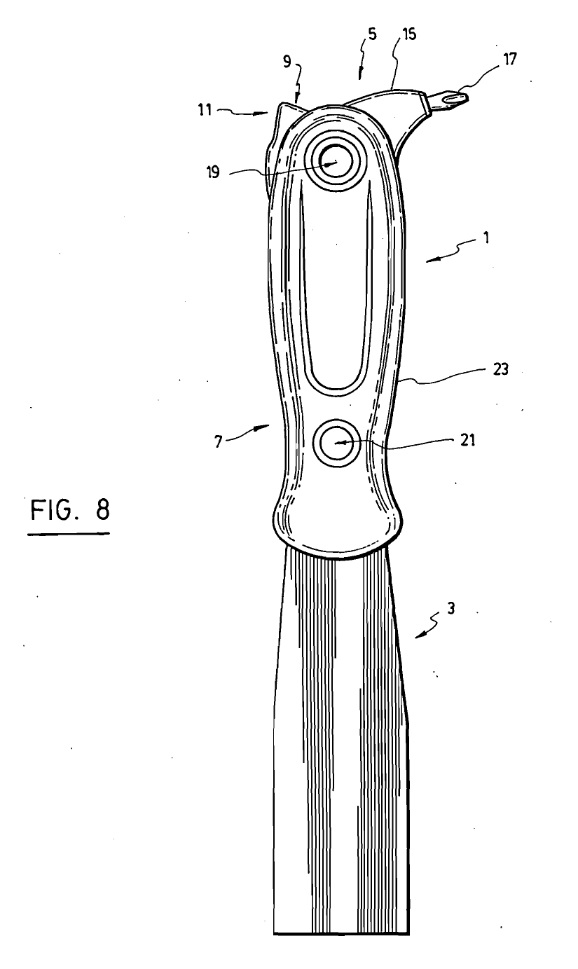

FIG. 9 is another perspective view of what is shown in FIG. 6, the tool being now shown with its screw bit in a non-operating configuration (“closed configuration”).

FIG. 10 is another perspective view of what is shown in FIG. 9.

FIG. 11 is a front plan view of what is shown in FIG. 9.

### DETAILED DESCRIPTION OF PREFERRED EMBODIMENTS OF THE INVENTION

In the following description, the same numerical references refer to similar elements. The embodiments, geometrical configurations, materials mentioned and/or dimensions shown in the figures are preferred, for exemplification purposes only.

Moreover, although the present invention was primarily designed for drywall applications, as well as carrying out other functions related thereto (e.g. plastering, scraping, screwing, tapping, etc.), it may be used with other types of materials and objects and in other fields, as apparent to a person skilled in the art. For this reason, expressions such as “drywall”, “tool”, “putty”, “knife”, “scraper”, “spatula”, etc., as used herein should not be taken as to limit the scope of the present invention and includes all other kinds of objects, materials and/or purposes with which the present invention could be used and may be useful.

Moreover, in the context of the present invention, the expressions “putty knife”, “scraper”, “spatula”, “tool”, “device”, “unit”, “apparatus”, and any other equivalent expression known in the art will be used interchangeably. Furthermore, the same applies for any other mutually equivalent expressions, such as “drywall”, “wall” and “surface”, as well as “tool handle” and “tool” for example, as also apparent to a person skilled in the art.

In addition, although the preferred embodiment of the present invention as illustrated in the accompanying drawings comprises various components and although the preferred embodiment of the tool handle 1 and resulting tool 7 (i.e. putty knife) as shown consists of certain geometrical configurations as explained and illustrated herein, not all of these components and geometries are essential to the invention and thus should not be taken in their restrictive sense, i.e. should not be taken as to limit the scope of the present invention. It is to be understood, as also apparent to a person skilled in the art, that other suitable components and cooperations thereinbetween, as well as other suitable geometrical configurations may be used for the tool handle 1 and resulting tool 7, and corresponding parts, according to the present invention, as briefly explained and as can be easily inferred herefrom by a person skilled in the art, without departing from the scope of the invention.

Broadly described, the tool handle 1 according to the present invention, as shown in the accompanying drawings, is a device which, in its preferred intended use, is an improved tool handle 1, to be appropriately mounted onto a given blade 3 or extremity (i.e. other component), so as to form a resulting utility tool 7, such as, for example, a putty knife, a spatula for joints, and/or the like, said tool handle 1 being preferably provided with a mechanism 5 of screw bit enabling to fasten or screw fasteners such as screws, and the like, into a given wall surface. As can be easily understood when referring to the accompanying drawings, the screw bit mechanism 5 is preferably one that is integrated to the tool handle 1, and one that is preferably retractable, so as to be operated at least between two (2) configurations, namely an operating (i.e. “opened”, “elevated”, etc.) configuration and a non-operating (i.e. “closed”, “nested”, etc.) configuration, wherein several intermediate configurations could also be provided, as can be easily understood by a person skilled in the art.

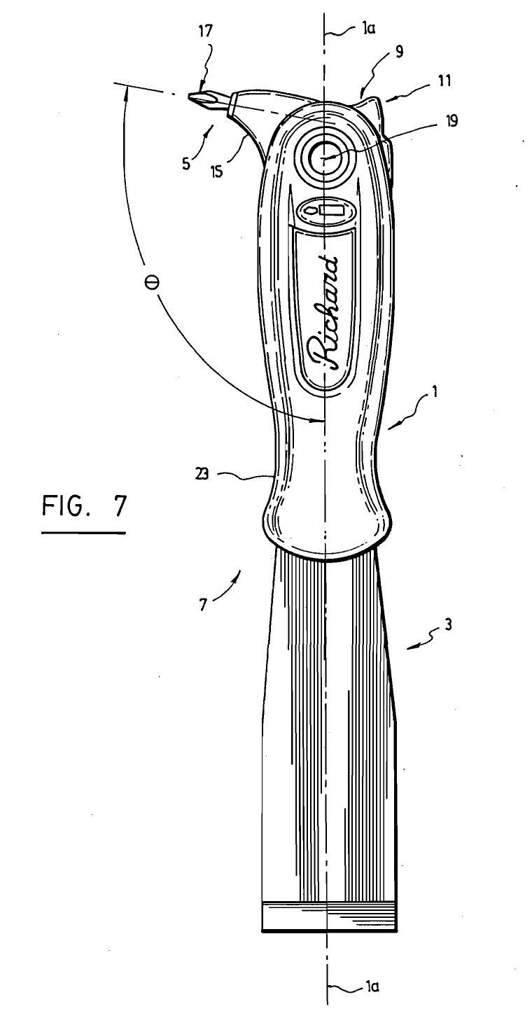

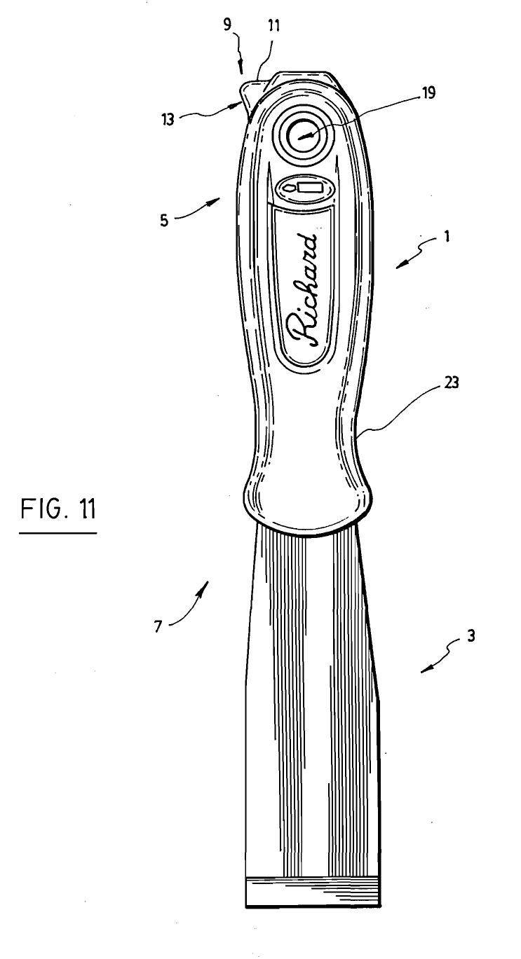

As also shown in the accompanying drawings, the utility tool 7, such a putty knife, includes an elongated handle 1 for manual handling of the utility tool 7, a blade 3 and a screw bit mechanism 5. The handle 1 extends substantially along a longitudinal axis 1a, and has front and rear portions. The blade 3 has an anchoring portion anchored within the handle 1 and an operating portion extending out from the front portion of the handle 1. The screw bit mechanism 5 is rotatably mounted about the rear portion of the handle 1, has a screw bit 17, and is operable between a non-operating configuration where the screw bit 17 is nested within the handle 1, and an operating configuration where the screw bit 17 is drawn out of the handle 1 and securely maintained in a fixed configuration so as to be positioned at a slanted angle θ with respect to the longitudinal axis 1a of the handle 1, as can be easily understood when contrasting FIGS. 7 and 11, for example. Preferably, the slanted angle θ is comprised between about 90 degrees and about 180 degrees with respect to the longitudinal axis of the handle, as also shown, and this provides substantial advantages, as will be described in greater detail hereinbelow.

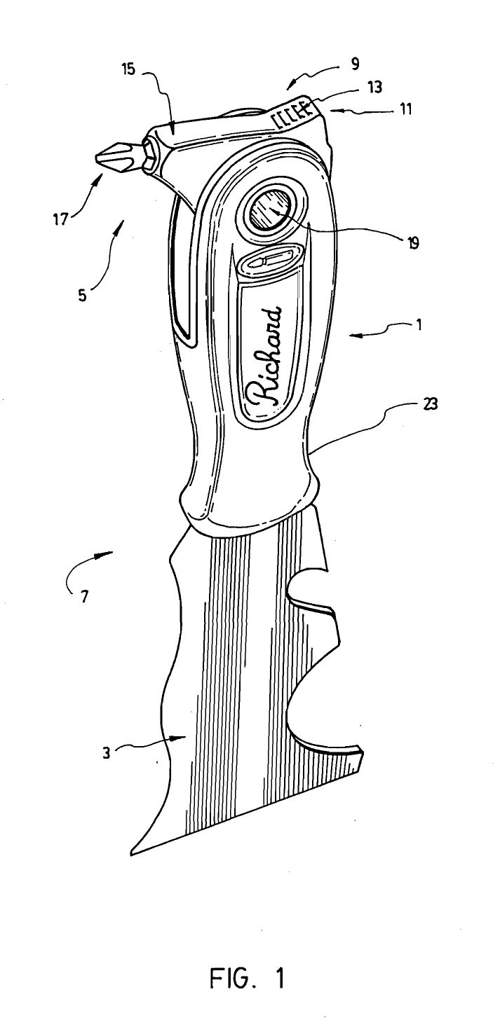

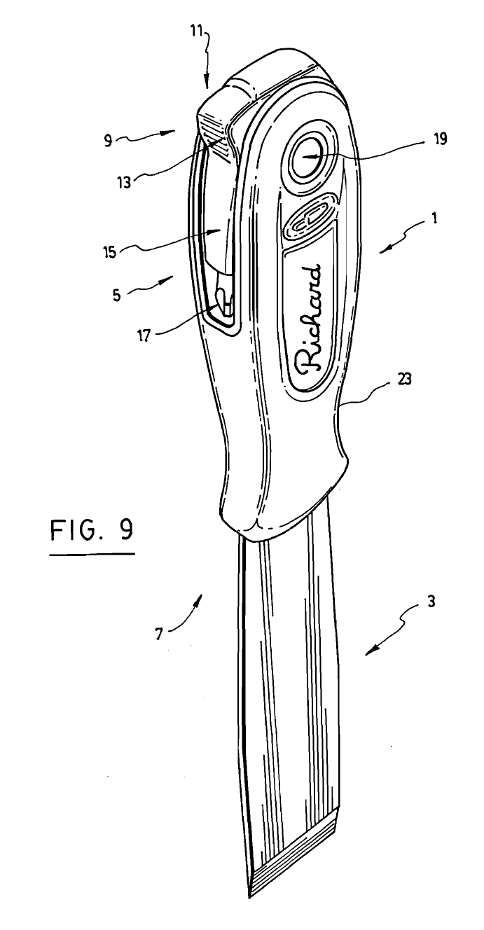

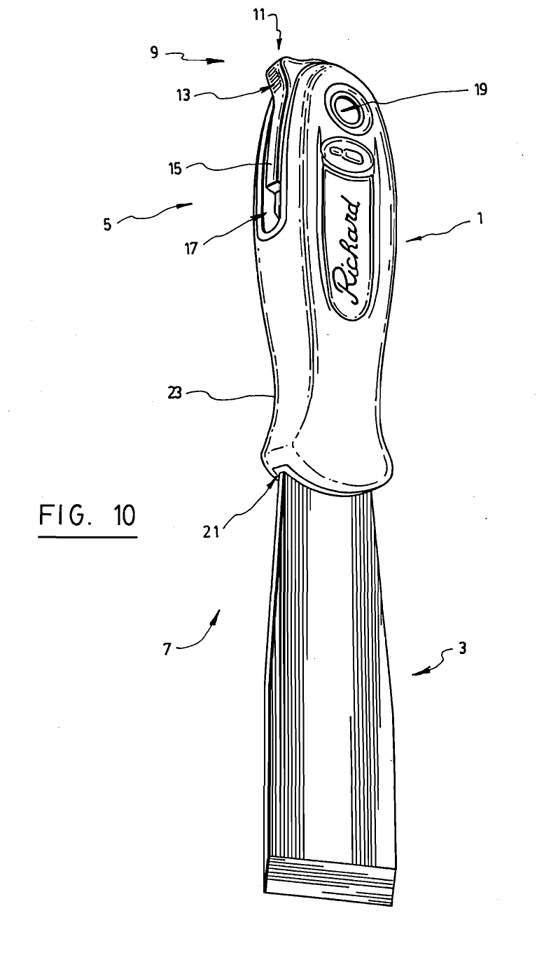

As can also be easily understood by a person skilled in the art when referring to the accompanying drawings, the tool handle 1 is preferably securely affixed to a given blade 3, or other component, so as to form the resulting tool 7. The tool handle 1 preferably comprises an inner core 21 made of a substantially rigid material, such as a proper plastic or the like, while being provided with corresponding overlaying portions 23 preferably made of a more soft material, such as an elastomeric material, for improving manipulation and grip of the tool handle 1 and resulting tool 7. As previously explained, the tool 7 is preferably provided with a screw bit mechanism 5 being configured preferably so as to be rotatably activated between retracted and operating configurations, the screw bit mechanism 5 being provided with a least one finger receiving portion 9 for enabling a comfortable and ergonomic activation of the screw bit mechanism 5 via a corresponding finger of the hand of the user of the tool 7 according to the present invention. The finger receiving portion 9 preferably comprises a protuberance 11 extending beyond a peripheral layout of the tool handle 1, preferably at a rear portion of the tool handle 1, as better shown in FIG. 1, said protuberance 11 being preferably provided with a series of corresponding transversal ribs 13 for facilitating a better grip of said finger receiving portion 9. The screw bit mechanism 5 preferably comprises a support portion 15 for receiving at least one corresponding screw bit 17 intended to be used for carrying out tasks similar to those of screwdrivers and the like, such as screwing fasteners (screws, etc.) into drywall and other like surfaces. The screw bit mechanism 5 is preferably configured so that its support portion 15 and corresponding screw bit 17 are preferably retracted and lodged within the tool handle 1, as better shown in FIGS. 9-11, when the screw bit mechanism 5 is operated into the retracted configuration.

As can be easily understood by a person skilled in the art when referring to the accompanying drawings, the tool handle 1 as briefly explained herein and exemplified in the accompanying drawings, could be used with a variety of different tools, and thus, the blade 3 or other component used with the tool handle 1 can be various, depending on the particular applications for which the resulting tool 7 is intended for, as also apparent to a person skilled in the art.

Moreover, as also exemplified in the accompanying drawings, the tool handle 1 is preferably provided with a corresponding bore 19 extending through the tool handle 1, for enabling to hang the tool 7 onto a corresponding hook or other suitable support structure, such as a construction belt, and the like. Thus, the screw bit mechanism 5 according to the present invention is preferably configured accordingly, as can be easily understood by a person skilled in the art, so as to enable the provision of such a bore 19 extending to said tool handle 1.

Preferably also, and as exemplified in the accompanying drawings, the tool handle 1 comprises different slanted edges and portions, as well as curved portions, so as to enable for a more comfortable, secured and ergonomic hand grip of the tool handle 1, and thus of the resulting tool 7.

Preferably also, the inner core of the tool handle 1 may be provided with corresponding ribs, flanges, shoulders, and/or recesses, for appropriately receiving the screw bit mechanism 5 and for sustaining the corresponding loads to which the resulting tool 7 and/or handle 1 thereof may be subjected to, as apparent to a person skilled in the art.

Thus, the tool handle 1 and resulting tool 7 according to the present invention preferably comprise an attractive design. As previously explained, the tool handle 1 is preferably provided with an elastomeric and/or rubberized material, to provide for a soft grip ergonomic handle. As also previously explained, the logo and colors used for the handle 1 may be various and interchangeable for allowing the manufacturing of different tools 7 depending on different trademarks used, so as to properly represent the manufacturers, distributors, wholesalers, or other parties involved in the commercialization and selling of the tool 7. As aforementioned, the tool 7 according to the present invention is provided with a novel tool handle 1 provided with an innovative screw bit mechanism 5, preferably intended for gypsum screws and the like, configured to be assembled on any type of blade or other component for assembling the resulting tool 7.

As previously explained, and as illustrated in the accompanying drawings, the screw bit mechanism 5 is preferably intended to be opened or operated with a single hand allowing the user of the present tool 7 to have the other hand free for carrying out other tasks. The screw bit mechanism 5 is also preferably configured so as to be used either by left-hand users or right-hand users, and thus, as can be appreciated from the accompanying drawings, is preferably intended to be symmetrical along a given plane of the tool 7. Furthermore, the opening or activation of the screw bit mechanism 5 can easily be carried out with a corresponding finger of the user, such as a thumb, the index, and/or other. As can also be easily understood by a person skilled in the art, the screw bit mechanism 5 is also preferably provided with resilient means, such as a spring for example, integrated into the screw bit mechanism 5 so as to keep the same, and more particularly the screw bit 17 thereof, in an elevated or extended configuration when operated into the operating configuration. Preferably also, the tool handle 1 according to the present invention is intended to be deprived of any mobile components in the screw bit mechanism 5 enabling for the system to be a simple and reliable one.

Preferably also, the screw bit mechanism 5, in a closed configuration, is provided with a flat end intended preferably to carry out the function of a “nailing cap” so as to namely enable the tapping on nails or other uneven surfaces on the wall surface prior to treatment thereof, with the present tool 7, such as the application of wall compound for covering joints and the like. Preferably also, as exemplified in the accompanying drawings, namely FIGS. 9-11, the screw bit mechanism 5, in the closed configuration, comprises rounded off portions for a greater comfort of a user of the tool handle 1 and resulting tool 7. Preferably also, the screw bit mechanism 5 and the blade 3 reach one another at the center of the tool handle 1 for enabling to transmit the force from the extremity of the blade 3 to the end cap (preferably made of steel and/or other suitable material) during impacts, as can be easily understood by a person skilled in the art.

The screw bit 17 of the screw bit mechanism 5, in a closed configuration, is preferably retracted inside of the tool handle 1 for enabling a solid grip on the tool 7 without having any component that extend beyond the natural shape of the tool handle 1. Preferably also, the screw bit 17, in the operating configuration, preferably has an angle of about 45 degrees with respect to the longitudinal axis of the tool handle 1, for enabling to have a greater lever effect for screwing fasteners, such as screws and the like. Furthermore, the support portion 15 of the screw bit 17, and the screw bit 17 itself, are preferably shaped, positioned and sized so as to define a given space between the wall surface and the tool handle 1, so as to also liberate the blade 3 of the tool 7 from the arm of the user, thus also avoiding or at the very least minimizing undesirable effects to the forearms of the arms of the users. Furthermore, the preferred geometric configuration illustrated in the accompanying drawings also enables for an improved transfer of the force for the screwing of fasteners and the like comparatively to the positioning of the screw bit 17 in the axis of the blade (i.e. in parallel).

Preferably also, the tool handle 1 comprises at one extremity, the mechanism with cap for chasing nails, and at the other extremity, an opening for enabling to assemble the tool handle 1 with any other suitable type of blade 3 or complementary component, for assembling the resulting tool 7.

It is worth mentioning also that several modifications could be made to the present tool 7 without departing from the scope of the present invention, as apparent to a person skilled in the art. For example, the tool handle 1 may be provided with a chamber or other suitable means for allowing an interchangeability of screw bits 17 with the corresponding support portion 15 of the screw bit mechanism 5. Furthermore, the screw bit mechanism 5 could also be altered so as to be triggered via a corresponding activation button, in which case, the screw bit 17 would be preferably spring loaded, so that upon activation of said activation button, the screw bit 17 and corresponding support portion 15 would be elevated via the action of the spring load, without having to resort to the activation of a finger receiving portion 9 (this latter component could be thus avoided), as can be easily understood by a person skilled in the art.

As can be easily understood from the accompanying drawings, and depending on the particular applications for which the present tool 7 is intended for, the handle 1 thereof is preferably made of a substantially rigid material, such as plastic, and the like, in order to be able to properly sustain corresponding loads subjected thereto by users or other corresponding tools to be used with the tool. Preferably also, so as to enable a more ergonomic and more comfortable and secure grip of the tool 7, the handle 1 thereof is provided with a corresponding covering intended to that effect. Preferably also, said covering is made of an elastomeric material, such as rubber and the like, for allowing a soft grip ergonomic handling of the tool 7, as can be easily understood by a person skilled in the art.

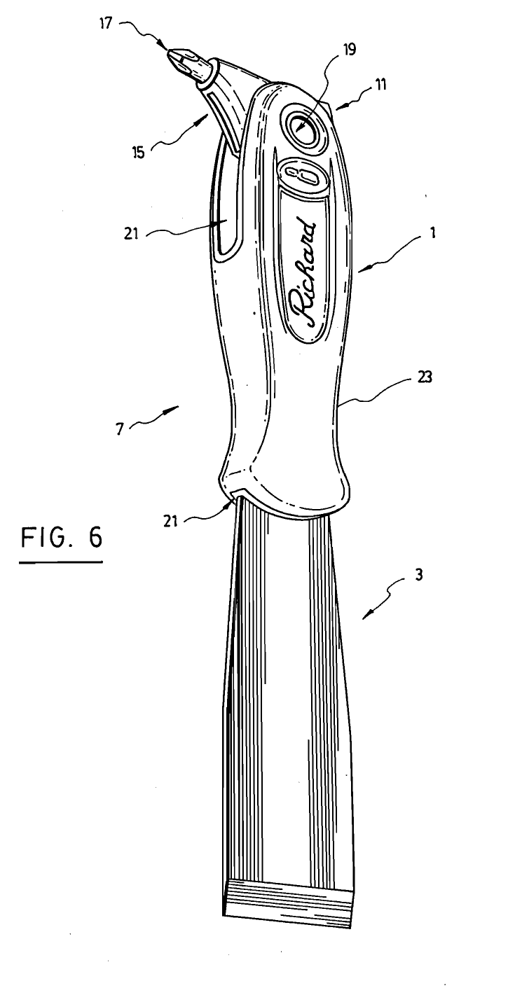

Referring now to the front portion of the tool handle 1, and as better illustrated in FIGS. 6 and 11, the blade 3 with which the treatment of a given surface is to be carried out with the present tool 7 is preferably operatively connected to an extremity of the front portion of the tool 7, and preferably also, rigidly connected thereto by suitable means, whether securely affixed thereto in a permanent manner (with fasteners, via a suitable manufacturing process, etc.), or whether in a removable manner, as can be easily understood by a person skilled in the art. It is worth mentioning also that several modifications could be made to the blade 3 according to the present invention, in that, this component is not necessarily limited to a blade per se, but could rather be replaced by any other suitable component, whether rigid or more flexible, made of plastic for example, which could be used for different purposes with which the present tool 7 could be used and may be useful. Indeed, it is worth mentioning, as can be easily understood by a person skilled in the art, that the blade 3 could be replaced by any other suitable object which could be rigidly or removably mounted to the front portion of the tool handle 1, as aforementioned, so as to enable to properly operate on a surface depending on the surface to be treated (for example, the blade 3 could made out of stainless steel for using with drywall and the like), and other applications with which the present tool 7 could be used and may be useful, as apparent to a person skilled in the art.

Preferably also, the blade 3 of the tool 7 according to the present invention is preferably treated metallurgically by means of a suitable treating process so as to resist to wear when used against different types of material and surfaces.

Preferably also, the covering of the handle 1 or of other portions of the present tool 7, and the rest thereof, are preferably selected so as to be of different colors, and different contrasting colors, so as to provide for a very attractive design of the tool 7, and so as to enable to commercialize the present tool 7 under the colors of the corresponding manufacturers and the like, for example. Furthermore, the handle 1 or other corresponding portions of the tool 7 may be provided with suitable continuous or discontinuous strands of numbers, letters, and/or other symbols conveying information, so as to transmit to the user corresponding information regarding the tool 7, its distributor, and/or its manufacturer, via a corresponding logo for example, or other suitable display of information. For example, a logo could be provided on the present tool 7 according to a double-molding process such as the one described in U.S. Pat. No. 6,726,868 having been obtained by the Assignee of the present application.

As previously explained, the at least one elongated flat blade 3 is adapted for operating on a surface and mounted on a rigid front portion of the tool handle 1. According to one embodiment of the invention, there is provided one blade 3 with an angle preset to optimize the performance of the tool 7. It will be understood by a person skilled in the art that in another embodiment of the invention, more than one blade 3 is preferably used and that there is preferably provided embodiments wherein the blade's angle is adjustable and wherein the blade 3 is interchangeable. For a longer lasting of the blade 3, the blade 3 is preferably quenched or plated, as aforementioned. Thus, the blade stands up to wear and corrosion.

Finally, and according to the present invention, the tool 7 and corresponding parts are preferably made of substantially rigid materials, such as metallic materials (stainless steel, etc.—particularly for the blade), hardened polymers, composite materials, and/or the like, whereas other components thereof (e.g. covering of the handle 1, etc.) according to the present invention, in order to achieve the resulting advantages briefly discussed herein, are preferably made of a suitably malleable and resilient material, such as a polymeric material (plastic, rubber, etc.), and/or the like, depending on the particular applications for which the tool handle 1 and resulting tool 7 are intended for and the different parameters in cause (load applied to the blade 3 and handle 1, required grip of the handle 1, etc.), as apparent to a person skilled in the art.

Furthermore, the present invention is a substantial improvement over the prior art in that, by virtue of its design and components, the tool 7 is simple and easy to use, as well as is simple and easy to manufacture and/or assemble, without compromising the reliability of its functions. Hence, it may now be appreciated that the present invention represents important advantages over other tools known in the prior art, in that the tool handle 1 and resulting tool 7 according to the present invention enable to carry out a variety of tasks with said single resulting tool 7, in a very ergonomic manner, as briefly explained hereinabove.

Of course, numerous modifications could be made to the above-described embodiments without departing from the scope of the invention, as defined in the appended claims.

1. A utility tool comprising:
an elongated handle for manual handling of the utility tool, the handle extending substantially along a longitudinal axis, and having front and rear portions;
a blade having an anchoring portion anchored within the handle and an operating portion extending out from the front portion of the handle; and
a screw bit mechanism rotatably mounted about the rear portion of the handle, the screw bit mechanism having a screw bit, and being operable between a non-operating configuration where the screw bit is nested within the handle, and an operating configuration where the screw bit is drawn out of the handle and securely maintained in a fixed configuration so as to be positioned at a slanted angle with respect to the longitudinal axis of the handle.

2. A utility tool according to claim 1, wherein the slanted angle is comprised between about 90 degrees and about 180 degrees with respect to the longitudinal axis of the handle.

3. A utility tool according to claim 1, wherein the handle comprises an inner core made of a substantially rigid material, while comprising corresponding overlaying portions made of an elastomeric material, for improving manipulation and grip of the handle and of the corresponding utility tool.

4. A utility tool according to claim 1, wherein the screw bit mechanism is provided with a finger receiving portion for enabling a swiveling of the screw bit mechanism into the operating configuration via a pressing action by a corresponding finger of a user of the utility tool onto said finger receiving portion.

5. A utility tool according to claim 4, wherein the finger receiving portion comprises a protuberance extending beyond a peripheral layout of the handle.

6. A utility tool according to claim 5, wherein the protuberance is provided with a series of corresponding transversal ribs for facilitating an improved grip and corresponding activation of the finger receiving portion.

7. A utility tool according to claim 1, wherein the screw bit mechanism comprises a swiveling support portion having a socket for receiving at least one corresponding removable screw bit intended to be used with the utility tool.

8. A utility tool according to claim 7, wherein the socket is complementary in shape and size to the at least one corresponding removable screw bit so as to retain the same within the socket, and wherein the socket is further cooperable in a magnetized manner with respect to said at least one corresponding removable screw bit so as to further retain the same within the socket.

9. A utility tool according to claim 8, wherein the screw bit mechanism is configured so that its swiveling support portion and corresponding screw bit are retracted and lodged within the handle of the utility tool when said tool is in the non-operating configuration.

10. A utility tool according to claim 9, wherein the screw bit mechanism is provided with a spring cooperable between the inside of the handle and the screw bit mechanism so as to maintain the same in an elevated configuration when operated into the operating configuration, and so as to further maintain the same in a closed configuration when operated into the non-operating configuration.

11. A utility tool according to claim 10, wherein the screw bit mechanism comprises rounded off portions for a greater comfort of a user of the handle and resulting utility tool when the screw bit mechanism is in the non-operating configuration.

12. A utility tool according to claim 1, wherein the screw bit mechanism is provided with a flat end positioned, shaped and sized to carry out the function of a nailing cap when the screw bit mechanism is in the non-operating configuration.

13. A utility tool according to claim 12, wherein the screw bit mechanism and the blade reach one another inside of the handle of the utility tool for enabling to transmit the force from the extremity of the blade to the nailing cap.

14. A utility tool according to claim 7, wherein the support portion of the screw bit mechanism, and the screw bit, are shaped, positioned and sized so as to define a given leeway space between the handle of the utility tool and a given wall surface when the utility tool is operated onto said given wall surface via its screw bit mechanism.

15. A utility tool according to claim 7, wherein the handle of the utility tool is provided with a chamber or other suitable storing space for storing and allowing an interchangeability of removable screw bits with the corresponding support portion of the screw bit mechanism.

16. A utility tool according to claim 1, wherein the screw bit mechanism is configured so as to be triggered via a corresponding activation button, the screw bit being spring loaded, so that upon activation of the activation button, the screw bit and corresponding support portion are elevated via the action of the spring load into the operating configuration.

17. A utility tool according to claim 1, wherein the handle is provided with a corresponding bore extending through the handle, for enabling to hang the utility tool onto a corresponding hook or other suitable support structure.

18. A utility tool according to claim 1, wherein at least one sign is produced on the handle, the sign being selected from the group consisting of names, words, numbers, logos, trademarks and symbols conveying information.

19. A utility tool according to claim 1, wherein either one of the handle, front portion and rear portion of the utility tool are provided with a reinforcement selected from the group consisting of ribs, flanges, and shoulders.

20. A putty knife comprising:
an elongated handle for manual handling of the putty knife, the handle extending substantially along a longitudinal axis, and having front and rear portions;
a blade having an anchoring portion anchored within the handle and an operating portion extending out from the front portion of the handle; and
a screw bit mechanism rotatably mounted about the rear portion of the handle, the screw bit mechanism having a screw bit, and being operable between a non-operating configuration where the screw bit is nested within the handle, and an operating configuration where the screw bit is drawn out of the handle and securely maintained in a fixed configuration so as to be positioned at a slanted angle with respect to the longitudinal axis of the handle;
wherein the slanted angle is comprised between about 90 degrees and about 180 degrees with respect to the longitudinal axis of the handle;
wherein the handle comprises an inner core made of a substantially rigid material, while comprising corresponding overlaying portions made of an elastomeric material, for improving manipulation and grip of the handle and of the corresponding putty knife;
wherein the screw bit mechanism is provided with a finger receiving portion for enabling a swiveling of the screw bit mechanism into the operating configuration via a pressing action by a corresponding finger of a user of the putty knife onto said finger receiving portion;
wherein the finger receiving portion comprises a protuberance extending beyond a peripheral layout of the handle;
wherein the protuberance is provided with a series of corresponding transversal ribs for facilitating an improved grip and corresponding activation of the finger receiving portion;
wherein the screw bit mechanism comprises a swiveling support portion having a socket for receiving at least one corresponding removable screw bit intended to be used with the putty knife;
wherein the socket is complementary in shape and size to the at least one corresponding removable screw bit so as to retain the same within the socket, and wherein the socket is further cooperable in a magnetized manner with respect to said at least one corresponding removable screw bit so as to further retain the same within the socket;
wherein the screw bit mechanism is configured so that its swiveling support portion and corresponding screw bit are retracted and lodged within the handle of the putty knife when said putty knife is in the non-operating configuration;
wherein the screw bit mechanism is provided with a spring cooperable between the inside of the handle and the screw bit mechanism so as to maintain the same in an elevated configuration when operated into the operating configuration, and so as to further maintain the same in a closed configuration when operated into the non-operating configuration;
wherein the screw bit mechanism comprises rounded off portions for a greater comfort of a user of the handle and resulting putty knife when the screw bit mechanism is in the non-operating configuration;
wherein the screw bit mechanism is provided with a flat end positioned, shaped and sized to carry out the function of a nailing cap when the screw bit mechanism is in the non-operating configuration;
wherein the screw bit mechanism and the blade reach one another inside of the handle of the putty knife for enabling to transmit the force from the extremity of the blade to the nailing cap;
wherein the support portion of the screw bit mechanism, and the screw bit, are shaped, positioned and sized so as to define a given leeway space between the handle of the putty knife and a given wall surface when the putty knife is operated onto said given wall surface via its screw bit mechanism;
wherein the handle is provided with a corresponding bore extending through the handle, for enabling to hang the putty knife onto a corresponding hook or other suitable support structure;
wherein at least one sign is produced on the handle, the sign being selected from the group consisting of names, words, numbers, logos, trademarks and symbols conveying information; and
wherein either one of the handle, front portion and rear portion of the putty knife are provided with a reinforcement selected from the group consisting of ribs, flanges, and shoulders.
